(19) United States
(12) Patent Application Publication
(10) Pub. No.: US 2020/0326041 A1
(43) Pub. Date: Oct. 15, 2020

(54) Led Tube

(71) Applicant: LEDVANCE GmbH, Garching bei Munich (DE)

(72) Inventors: Gang XU, Shenzhen (CN); Xiongqiang HE, Shenzhen (CN); Long CHEN, Shenzhen (CN)

(21) Appl. No.: 16/843,415

(22) Filed: Apr. 8, 2020

(30) Foreign Application Priority Data
Apr. 12, 2019 (CN) 201910295069.4

(51) Int. Cl. F21K 9/278; F21K 9/272; F21V 23/00; F21V 25/10; F21V 23/06; H05B 45/375

(52) U.S. Cl. CPC F21K 9/278; F21K 9/272; F21V 23/006; F21Y 2115/10; F21V 23/06; H05B 45/375; F21V 25/10

(57) ABSTRACT

An LED tube includes a translucent tubular body having an inner surface, an outer surface, a first end and a second end. The LED tube further includes a first end cap with a first pair of contact pins, arranged at the first end of the tubular body and a second end cap with a second pair of contact pins, arranged at the second end of the tubular body, an LED light engine with a plurality of LEDs and a driver circuit for driving the LED light engine. The driver circuit includes a first sub-circuit with at least one electronic component and a second sub-circuit with at least one electronic component.

### CROSS-REFERENCE TO RELATED APPLICATIONS

This application claims the benefit of Chinese patent application No. 201910295069.4 filed Apr. 12, 2019, which is hereby incorporated by reference herein in its entirety.

### TECHNICAL FIELD

The present application generally relates to LED tubes. In particular, the present discloser relates to so called LED retrofit tubes which are designed for mounting in light fixtures designed for fluorescent light tubes.

### BACKGROUND

Due to high efficiency and robustness of light emitting diodes (LEDs), LED-based lamps provide an attractive alternative for traditional lamps, such as incandescent lamps or low-pressure gas discharge fluorescent lamps. However, the replacement of fluorescent tubes by LED tubes is not always straightforward especially since the electrical ballasts used in the existing fluorescent tube light fixtures are usually configured for receiving and powering low pressure gas discharge lamps and not LED lamps. Furthermore, the electronic components required for driving LEDs take space inside the LED tubes and thus can considerably deteriorate the illumination characteristics of the LED tubes.

### SUMMARY

The object of the present application is to provide an LED tube with improved illumination characteristics.

According to one embodiment, an LED tube for mounting in a light fixture is provided. The LED tube comprises a translucent tubular body having an inner surface, an outer surface, a first end and a second end. The LED tube also comprises a first end cap which a first pair of contact pins, which is arranged at the first end of the tubular body, and a second end cap with a second pair of contact pins, which is arranged at the second end of the tubular body. The LED tube further comprises an LED light engine with a plurality of LEDs. In particular, the plurality of LEDs can be arranged as a linear LED array extending along the tubular body. The LED tube also comprises a driver circuit for driving the LED light engine. The driver circuit comprises a first sub-circuit with at least one electronic component and a second sub-circuit with at least one electronic component, wherein the at least one electronic component of the first sub-circuit is arranged at least partially inside the first end cap and the at least one electronic component of the second sub-circuit is arranged at least partially inside the second end cap.

Due to division of the driver circuit into two sub-circuits with electronic components arranged inside the first end cap and the second end cap, the both end caps can be used for receiving electrical components of the LED driver. By arranging the electrical components in the first end cap and the second end cap, the electronic components can be taken away from the path of the light emitted by the LEDs. In such way, essentially the whole surface of the tubular body can be illuminated by the LEDs. Furthermore, the so-called dark areas or areas of the tubular body which are not or not sufficiently illuminated or even covered, in particular by labels, for covering electronic components inside the tubular body can be reduced or avoided. In such way the overall luminous surface of the LED tubes can be increased as well.

The LED tube may comprise an LED circuit board extending inside the tubular body between the first end cap and the second end cap, wherein the first sub-circuit and the second sub-circuit are electrically connected via the LED circuit board. By connecting the first sub-circuit and the second sub-circuit via the LED circuit board, the LED driver can be easily divided without additional wiring or connectors.

The LED circuit board may comprise at least one conductive line extending along the LED circuit board, wherein the electrical connection between the first sub-circuit and the second sub-circuit is established. In particular, the at least one conductive line can be an essentially strait metallization line extending from one end of the LED circuit board to another end of the LED circuit board, which has only function of electrically connecting the first sub-circuit with the second sub-circuit and is not otherwise electrically connected to the LED light engine.

The LED circuit board may have a front surface and back surface opposite to the front surface, wherein the plurality of LEDs is attached to the front surface of the LED circuit board and the back surface of the LED circuit board is attached, in particular by an adhesive layer, to the inner surface of the tubular body. In this configuration the light emitted by the LEDs can spread inside the tubular body in such a way that an essentially homogeneous illumination of the tubular body can be achieved. The side of the tubular body at which the LED circuit board is attached can be place towards the light fixture such that dark stripe at the place of the attachment of the LED circuit board cannot influence much the overall illumination characteristics of the light fixture. The LED circuit board and/or the adhesive layer may be transparent in order to avoid or weaken the contrast of the dark stripe at the place of attachment of the LED circuit board.

In some embodiments, the LED circuit board is a flexible circuit board or flex board. The using of the flex-board as the LED circuit board can facilitate the assembly of the LED lamp, since the flexible ends of the flex-board can be bent for connecting to the first sub-circuit and the second sub-circuit. Thus, using of additional wiring can be avoided. The flex board can comprise have a two-side metallization such that the flex board can be electrically contacted from the both surfaces. The two-side metallization can be especially useful for easy assembling of the LED tube, since the flex board can be contacted with both sides to the first circuit board and the second circuit board.

The LED driver may comprise an EMI (electro-magnetic interference) filter connected to the first pair of contact pins. In the input of the EMI filter can be connected via fuse to the first pair of contact pins. The first sub-circuit may comprise at least one component of the EMI filter. The EMI filter can reduce the electromagnetic interference for smooth functioning of the LED driver circuit when the AC mains is applied on the first pair of contact pins.

The LED driver may comprise a bridge rectifier, wherein the first sub-circuit comprises at least one component of the bridge rectifier. The at least one electrical component of the EMI filter and/or bridge rectifier can be chosen by taking into account its physical size, as well as the physical size of other electronic components of the driver, such that the electronic components can be efficiently hidden behind the first end cap and the second and cap. In particular, the electronic components can be mounted in the end caps is such a way that they are at least partially covered from direct view if viewed from a direction perpendicular to the symmetry axis of the tubular body.

The at least on electronic component of the first sub-circuit, which is mounted in the first end cap, comprises at least one inductive component and/or capacitive component at least partially covered by the first end cap. Further, the at least one electronic component of the second sub-circuit may comprise at least on inductive and/or capacitive component at least partially covered by the second end cap. In general, capacitive and inductive elements take a large portion of the whole space occupied by LED driver components. Thus, by hiding the capacitive and/or inductive elements under the end caps of the LED tube, the luminous surface of the tubular body can be efficiently increased.

The LED driver may comprise a buck converter, in particular for stepping down the DC voltage delivered by the bridge rectifier to the level suitable for driving the LED light engine, wherein the second sub-circuit comprises at least one component of the buck converter. The buck converter may comprise a switching circuit with a high frequency power transformer. The high frequency power transformers take small volume and are not expensive.

In some embodiments the LED tube comprises a first circuit board mounted inside the first end cap, wherein the at least one electronic component of the first sub-circuit is mounted on the first circuit board.

The LED tube may also comprise a second circuit board mounted inside the second end cap, wherein the at least one electronic component of the second sub-circuit is mounted on the second circuit board. Circuit boards are especially suitable for mounting a plurality of electrical components, such that the whole circuitries can be easily mounted inside the end caps.

In some embodiments the EMI filter and the bridge rectifier are mounted on the first circuit board and the buck converter is mounted on the second circuit board, wherein the first circuit board and the second circuit board are connected via two conductive line of the LED circuit board. This configuration is particularly suitable for dividing complete functional parts arranged at the first end and the second end, respectively, since the output of the bridge rectifier can be electrically connected to the input of the buck converter via the two conductive lines of the LED circuit board. Thus, the driver electronics can be divided into spatially separated two with a simple layout of the LED circuit board.

In some embodiments, the LED tube comprises a fuse connected to the second pair of contact pins that the pins of the second pair of contact pins are electrically connected via the fuse. By providing the fuse connecting the two pins of the second pair of contacts, the LED tube can be configured for operation in light fixtures with conventional control gears (CCG).

In the following description, details are provided to describe the embodiments of the present specification. It shall be apparent to one skilled in the art, however, that the embodiments may be practiced without such details.

### BRIEF DESCRIPTION OF THE DRAWINGS

Some parts of the embodiments have similar parts. The similar parts may have same names or similar part numbers. The description of one part applies by reference to another similar part, where appropriate, thereby reducing repetition of text without limiting the disclosure.

FIG. 1 shows a schematic exploded view of an LED tube according to an embodiment,

FIG. 2 shows a partial cross-sectional view of the LED tube according to FIG. 1,

FIG. 3 shows a partial cross-sectional view of the LED tube according to FIG. 1, and

FIG. 4 shows the circuit diagram of the LED tube of FIG. 1.

### DETAILED DESCRIPTION OF THE INVENTION

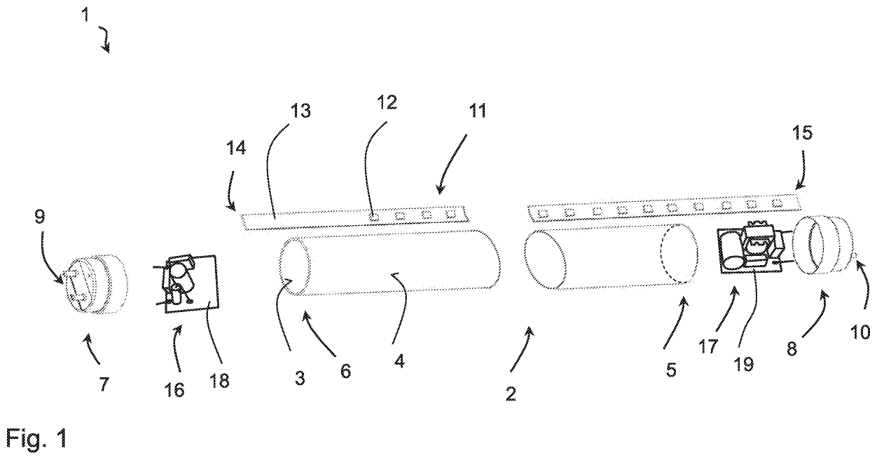

FIG. 1 shows a schematic exploded view of an LED tube according to an embodiment. The LED tube 1 includes an essentially translucent tubular body 2. The tubular body 2 has an inner surface 3, an outer surface 4, a first end 5 and a second end 6.

The LED tube 1 further comprises a first end cap 7 arranged at the first end 5 of the tubular body 2 and a second end cap 8 with a first pair 9 of contact pins, arranged at the second end 6 of the tubular body 2, and a second end cap 8 with a second pair 10 of contact pins and a second pair 10 of contact pins, respectively.

The LED tube 1 further comprises an LED light engine 11 with LEDs 12 mounted on an LED circuit board 13 which is arranged inside the tubular body 2. The LED circuit board 13 has an elongated rectangular shape and extends along the tubular body 2 between the first end cap 7 and the second end cap 8. The LED circuit board 13 has a first end 14 arranged close to the first end 5 of the tubular body and a second end 15 arranged close to the second end 6 of the tubular body 13.

The LED tube 1 also comprises an LED driver circuit for driving the LED light engine 11. The LED driver circuit comprises a first sub-circuit 16 and a second sub-circuit 15. The first sub-circuit 16 comprises electronic components mounted on a first circuit board 18 or PCB (printed circuit board) and the second sub circuit comprises electronic components mounted on a second circuit board 19.

The translucent tubular body 2 can be transparent or diffusively scattering. The tubular body can be out of glass or plastics. In some embodiments, the tubular body 2 comprises a transparent body covered with a light scattering coating for producing a diffused light.

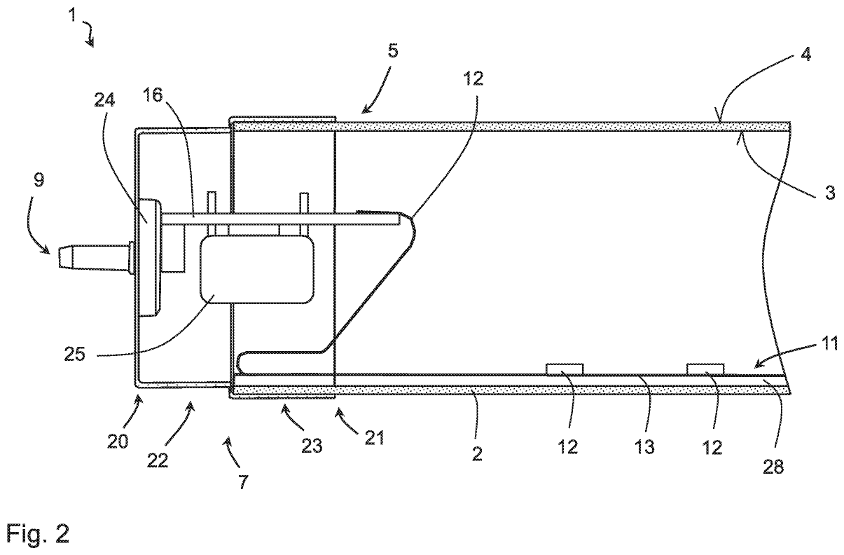

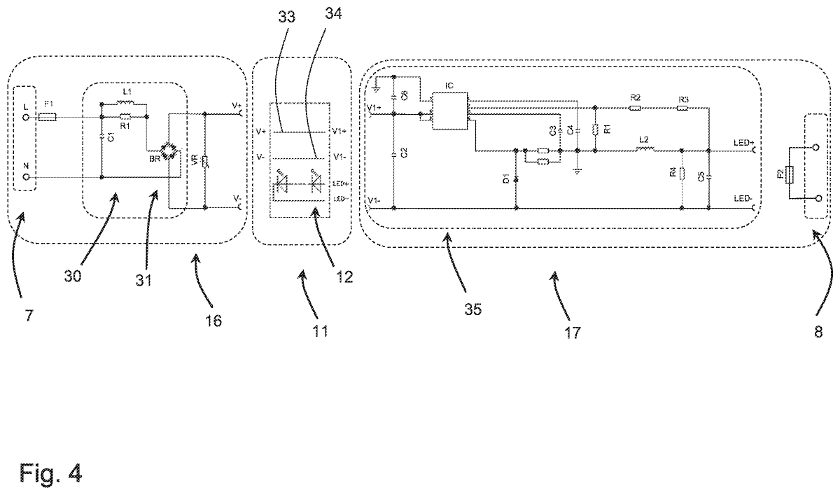

FIG. 2 shows a partial cross-sectional view of the LED tube according to FIG. 1. In particular, FIG. 2 shows the LED tube assembly in the region of the first end cap 7. The first end cap 7 has an essentially cylindrical shape with a closed end 20 and an open end 21. The first end cap 7 comprises a first cylindrical region 22 adjacent to the closed end 20, a second cylindrical region 23 adjacent to the open end 21 and a base 24 at the closed end 20 of the first cap 7, the first pair 9 of contact pins and the first circuit board 16 are attached to the base 24 of the first cap 7. An electrical component 25 is mounted on the first circuit board 16 such that is covered from direct view if viewed from a direction perpendicular to the symmetry axis of the tubular body 2. The electronic 25 component is a capacitor of an EMI filter, see FIG. 4 below.

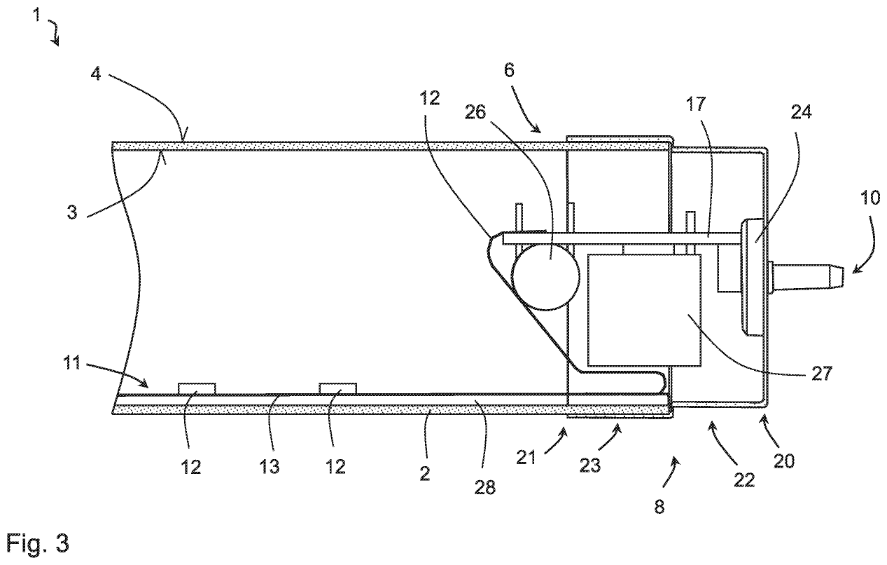

FIG. 3 shows a partial cross-sectional view of the LED tube according to FIG. 1. In particular, FIG. 3 shows the LED tube assembly in the region of the second end cap 8. The second end cap 8 is essentially similar to the first end cap 7. In particular, the second end cap 8 has the shape of a cylinder with a closed end 20 and an open end 21. The second end cap 8 also comprises a first cylindrical region 22 adjacent to the closed end 20, a second cylindrical region 23 adjacent to the open end 21 and a base 24 at the closed end 20 of the second end cap 8. The second pair 10 of contact pins and the second circuit board 17 is attached to the base 22 of the second end cap 8. Electrical components 26 and 27 are mounted on the second circuit board 17 in such a way that the electronic component 26 is partially covered and the electronic component 27 is completely covered from a direct view if viewed from a direction perpendicular to the symmetry axis of the tubular body 2. In this embodiment, the electronic component 27 is a transformer and the electronic component 26 is an output capacitor of a buck converter, see FIG. 4 below.

In this embodiment, the LED circuit board 13 is formed as a flexible circuit board or flex board. The LEDs 12 are mounted on one surface (frontside) of the flex board. The other surface opposite to the frontside backside of the LED circuit board 13 is attached with an adhesive layer 28 to the inner surface 3 of the tubular body 2. The two opposite ends of the flexible LED circuit board 13 are bent in an S-shape and connected to the first circuit board 16 and the second circuit board 17, respectively, in such a way that an electrical connection between the first sub-circuit 14, the second sub-circuit 15 and the LED light Engine 11, is established. Thus, the LEDs 12 can be driven by the LED driver circuit. The S-shape bend of the flex board is especially suitable for covering the electrical components arrange close to the end caps 7 and 8 of the LED tube 1.

FIG. 4 shows the electrical circuit diagram of the LED tube of FIG. 1. For a better visualization, the electrical circuit diagram of the LED tube 1 is depicted as separate functional units indicated by dashed lines. In particular, FIG. 4 shows the first sub-circuit 16, the second sub-circuit 17 and the LED light engine 11 as separate functional units.

The first sub-circuit 16 comprises a first input contact L, a second input contact N, a first fuse F1, an electro-magnetic interference filter 30 (EMI filter), a bridge rectifier 31 with diodes D, a voltage stabilizer VR, a positive output contact V+, and a negative output contact V−. The EMI filter 30 comprises an input capacitor C1, a resistor R1 and an inductor L1, which are connected to form a low pass filter for preventing high frequency interference to reach the bridge rectifier.

The LED light engine 11 comprises a number of LEDs 12 and a circuitry for supplying the LEDs with electric current. The LEDs 12 and the circuitry are arranged on the LED circuit board 13. The LED light engine 11 comprises a positive input contact V+ and a negative input contact V−. The positive input contact V+ and the negative input contact V− are arranged at the first end of the LED circuit board 13. The LED light engine 11 further comprises a positive output contact V1+, a negative output contact V1−, a positive input contact LED+, and a negative input contact LED−. The positive output contact V1+, the negative output contact V1−, the positive input contact LED+, and the negative input contact LED− are arranged at the second end of the LED circuit board 13.

The circuitry of the LED light engine 11 comprises a first conductive line 33 extending along the LED circuit board 13 from the positive input contact V+ to the positive output contact V1+. The circuitry of the LED light engine 11 also comprises a second conductive line 34 extending along the LED circuit board 13 from the negative input contact V− to the negative output contact V1−.

The second sub-circuit 17 comprises a positive input contact V1+, a negative input contact V1−, a positive output contact LED+, and a negative output LED−. The second-sub-circuit 17 also comprises a buck converter integrated circuit (IC), capacitors C2, C3, C4, C4, C5 and C6 as well as resistors R1, R2, R3, R4 and a diode D1, as well as inductor L2 which are connected to form a buck converter 35 for providing a suitable DC voltage to the LED light engine 11.

In the assembled state of the LED tube 1, the positive output contact V+ of the first sub-circuit 16 is electrically connected with the positive input contact V+ of the LED light engine 11 and the negative input contact V− of the first sub-circuit 16 is electrically connected with the negative input contact V− of the LED light engine 11. Further, the positive output contact V1+ of the LED light engine 11 is electrically connected with the positive input contact V+ of the second sub-circuit 17 and the negative output contact V− of the LED light engine 11 is electrically connected with the negative input contact V− of the second sub-circuit 17. The positive output contact LED+ of the buck converter 35 is electrically connected with the positive input contact LED+ of the LED light engine 11 and the negative output contact LED− of the buck converter is electrically connected with the negative input contact LED− of the LED light engine 11. The electrical connections between the first sub-circuit 16, the second sub-circuit 17 and the LED light engine are not shown in FIG. 4, for the sake of simplicity.

During the operation, the AC mains voltage signal is applied between the first input contact L and the second input contact N of the first sub-circuit 11. The EMI filter 30 filters the applied AC voltage signal and delivers a filtered AC signal to the bridge rectifier 31 which rectifies the filtered AC signal to a DC output voltage of the first sub-circuit 16. The DC output voltage is stabilized by the voltage stabilizer VR which is connected between the positive output contact V+ and the negative output contact V− of the first sub-circuit. The voltage stabilizer may comprise a Zener diode for stabilizing the output voltage of the bridge rectifier.

The stabilized output DC voltage of the first sub-circuit 16 is transmitted over the first conductive line 33 and the second conductive line 34 of the LED light engine to the second sub-circuit 17, in particular to the positive input contact V1+ and the negative input contact V1− of the buck converter 35. The buck converter 35 is configured in such a way that the DC voltage applied between the positive input V1+ und negative input V1− of the buck converter 35 is converted into a lower DC voltage between the positive output LED+ und the negative output LED− of the buck converter which are electrically connected with the positive input contact LED+ and negative input contact LED− of the LED light engine 11 for driving the LED light engine 11. Thus, the LED driver is divided into two spatially separate parts which are arranged at the opposite ends of the LED light engine 11, located at the end caps 7 and 8 of the LED tube 1. In particular, due to the arrangement of the conductive lines 33 and 34 along the LED circuit board 13, the electrical connection between these two separate parts can be easily established without additional connective wires.

Due to the separation of the LED driver into two parts, the both caps 7 and 8 can be used for receiving electrical components of the LED driver in such way that the LED driver components can be effectively hidden under the both end caps. Thus, the length of dark areas of the lamps can be reduced and accordingly effective surface of the surface can be increased.

In some embodiments the LED tube 1 is configured as a traditional T8 LED tube with accordingly designed end caps. The length of end caps 7 and 8 can be e.g. approximately 19 mm, while the diameter of the first cylindrical region 18 and the second cylindrical region 19 can be approximately 25.5 mm and 27.8 mm, respectively.

While at least one exemplary embodiment has been presented in the foregoing detailed description, it should be appreciated that a vast number of variations exists. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments.

1. An LED tube for mounting in a light fixture, the LED tube comprising:
a translucent tubular body having an inner surface, an outer surface, a first end and a second end,
a first end cap with a first pair of contact pins, the first end cap being arranged at the first end of the tubular body,
a second end cap with a second pair of contact pins, the second end cap being arranged at the second end of the tubular body,
an LED light engine with a plurality of LEDs, and
a driver circuit for driving the LED light engine, the driver circuit comprising a first sub-circuit with at least one electronic component and a second sub-circuit with at least one electronic component,
wherein the at least one electronic component of the first sub-circuit is arranged at least partially inside the first end cap and the at least one electronic component of the second sub-circuit is arranged at least partially inside the second end cap.

2. The LED tube according to claim 1, wherein the LED light engine comprises an LED circuit board extending inside the tubular body between the first end cap and the second end cap, and wherein the first sub-circuit and the second sub-circuit are electrically connected via the LED circuit board.

3. The LED tube according to claim 1, wherein the LED circuit board comprises at least one conductive line extending along the LED circuit board, and wherein the electrical connection between the first sub-circuit and the second sub-circuit is established over the at least one conductive line.

4. The LED tube according to claim 2, wherein the LED circuit board has a front surface and a back surface opposite to the front side, and wherein a plurality of LEDs is attached to the front side of the LED circuit board and the back side of the LED circuit board is attached to the inner surface of the tubular body.

5. The LED tube according to claim 2, wherein the LED circuit board is a flexible circuit board.

6. The LED tube according to claim 1, wherein the LED driver comprises an EMI filter connected to the first pair of contact pins, and wherein the first sub-circuit comprises at least one electrical component of the EMI filter.

7. The LED tube according to claim 1, wherein the LED driver comprises a bridge rectifier, and wherein the first sub-circuit comprises at least one electrical component of the bridge rectifier.

8. The LED tube according to claim 1, wherein the LED driver comprises a buck-converter, and wherein the second sub-circuit comprises at least one component of the buck-converter.

9. The LED tube according to claim 8, wherein the buck-converter comprises a high frequency power transformer.

10. The LED tube according to claim 1, wherein the at least one electronic component of the first sub-circuit comprises at least one inductive component and/or capacitive component at least partially covered by the first end cap.

11. The LED tube according to claim 1, wherein the at least one electronic component of the second sub-circuit comprises at least one inductive component and/or at least one capacitive component at least partially covered by the second end cap.

12. The LED tube according to claim 1, wherein the LED tube comprises a first circuit board mounted inside the first end cap, and wherein the at least one electronic component of the first sub-circuit is mounted on the first circuit board.

13. The LED tube according to claim 1, wherein the LED tube comprises a second circuit board mounted inside the second end cap, and wherein the at least one electronic component of the second sub-circuit is mounted on the second circuit board.

14. The LED tube according to claim 1, the LED tube comprises a fuse connected to the second pair of contact pins such that the pins of the second pair of contact pins are electrically connected via the fuse.

15. The LED tube according to claim 1, wherein the LED tube is configured as an LED retrofit tube for substituting fluorescent tubes.
